(19) United States
(12) Patent Application Publication
(10) Pub. No.: US 2012/0095919 A1
(43) Pub. Date: Apr. 19, 2012

(54) SYSTEMS AND METHODS FOR AUTHENTICATING ASPECTS OF AN ONLINE TRANSACTION USING A SECURE PERIPHERAL DEVICE HAVING A MESSAGE DISPLAY AND/OR USER INPUT

(76) Inventors: Annmarie D. Hart, Seal Beach, CA (US); Ronald S. Indeck, St. Louis, MO (US); Kiran Gandhi, Seal Beach, CA (US); Phillip A. McCauley, Carson, CA (US); Lawrence R. Meyers, Rancho Palos Verdes, CA (US)

(21) Appl. No.: 13/274,227

(22) Filed: Oct. 14, 2011

Related U.S. Application Data
(60) Provisional application No. 61/393,810, filed on Oct. 15, 2010.

(51) Int. Cl. H04L 9/32; H04L 9/00; G06Q 40/00; G06F 15/16

(52) U.S. Cl. 705/44; 726/3; 713/169; 726/5; 726/9; 713/168

(57) ABSTRACT

Systems and methods for authenticating aspects of an online transaction using a secure peripheral device having a message display and/or user input are provided. One such method for establishing a secure communication channel between a computer peripheral device and a host includes responding to requests to authenticate the peripheral device, authenticating the host, receiving one or more messages from the host, displaying the one or more messages on a display of the peripheral device, receiving user input in response to the one or more messages, sending the user response to the host.

### CROSS-REFERENCE TO RELATED APPLICATION(S)

The present application claims the benefit of Provisional Application No. 61/393,810, filed Oct. 15, 2010, entitled “SYSTEMS AND METHODS FOR AUTHENTICATING ASPECTS OF AN ONLINE TRANSACTION USING A SECURE PERIPHERAL DEVICE HAVING A MESSAGE DISPLAY AND/OR USER INPUT”, the entire content of which is incorporated herein by reference.

### FIELD

The present invention relates generally to authentication systems, and more specifically to systems and methods for authenticating aspects of an online transaction using a secure peripheral device having a message display and/or user input.

### BACKGROUND

The security of personal financial and identification information is an important concern for consumers. Such information is commonly stored on data cards and includes account numbers, expiration dates, the names of card users, identification numbers, or other such information. Often phishing and spoofing scams are designed to acquire the personal financial information of everyday consumers from their personal data cards by fraud or by other deceptive means. Many of these schemes rely on the ability to intercept data travelling between a user instrument such as a personal computer and a server conducting financial transactions.

Users of personal computers, web servers and networks connecting the two computing devices are susceptible to a multitude of attacks including phishing or spoofing scams, browser redirects (e.g., pharming), fake websites, key stroke loggers, man-in-the-middle, man-in-the-browser, and other similar attacks. While conventional security tactics have attempted to prevent many of these attacks, man-in-the-middle and man-in-the-browser attacks can easily defeat many of these tactics. In particular, man-in-the-middle and man-in-the-browser attacks allow thieves to modify transactions and transaction details. For example, thieves can use such attacks to change payee account data, change transactions amounts, insert an unauthorized payee, insert unauthorized transactions, or other unscrupulous actions. As such, a system for conducting secure online transactions despite the multitude of dangerous schemes and attacks that plague users of personal computers, web servers, and connecting networks, would be highly desirable.

### SUMMARY

Aspects of the invention relate to systems and methods for authenticating aspects of an online transaction using a secure peripheral device having a message display and/or user input. In one embodiment, the invention relates to a system for establishing a secure communication channel between a computer peripheral device and a host, the system including a host, a computer coupled to the host via an unsecured communication channel, and a peripheral device coupled to the computer and including a display configured to display one or more messages received from the host, at least one input configured to receive information from a user; and processing circuitry configured to establish a secure communication channel with the host using a mutual authentication process, receive the messages from the host via the computer using the secure communication channel, and send the user information to the host via the computer using the secure communication channel.

In another embodiment, the invention relates to a method for establishing a secure communication channel between a computer peripheral device and a host, the method including responding to requests to authenticate the peripheral device, authenticating the host, receiving one or more messages from the host, displaying the one or more messages on a display of the peripheral device, receiving user input in response to the one or more messages, sending the user response to the host.

### BRIEF DESCRIPTION OF THE DRAWINGS

FIG. 1 is a schematic block diagram of a transaction system including a user personal computer, a web server, a trusted authentication server, an attacker, and a card reader having a message display in accordance with an embodiment of the invention.

FIG. 2 is a schematic block diagram of a card reader with a display in accordance with an embodiment of the invention.

FIG. 3 is a flow chart of an overall process for authenticating aspects of a card reader transaction in accordance with an embodiment of the invention.

FIG. 4 is a flow chart of a process for authenticating aspects of a card reader transaction at a card reader having a message display in accordance with an embodiment of the invention.

FIG. 5 is a flow chart of a process for authenticating aspects of a card reader transaction at a web server in accordance with an embodiment of the invention.

FIG. 6 is a flow chart of a process for executing a mutual authentication process between a card reader and a web server in accordance with an embodiment of the invention.

FIG. 7 is a functional block diagram/flow chart of a challenge-response mutual authentication process that can be performed between a card reader, a web server, and an authentication server in accordance with an embodiment of the invention.

FIG. 8 is a schematic block diagram/screen shot of displays of a user PC and a card reader illustrating a process for confirming details of a transaction displayed on the secure message display of the card reader in accordance with an embodiment of the invention.

FIG. 9 is a screen shot of a user PC display illustrating a process for confirming details of a transaction displayed on the secure message display of the card reader in accordance with an embodiment of the invention.

### DETAILED DESCRIPTION

Referring now to the drawings, embodiments of peripheral devices having a secure messaging display are illustrated. The peripheral devices can be coupled to a user PC and configured to establish a secure communication channel with a web server or trusted authentication server using preselected encryption keys stored in the peripheral device, or generated using appropriate algorithms executing on the peripheral device, that are also known to the web server or trusted authentication server. The peripheral devices are also capable of performing various mutual authentication processes to verify the peripheral device's authenticity or to confirm the authenticity of either or both of the web server or trusted authentication server.

The peripheral devices can have one or more user inputs to capture user feedback often related to messages displayed on the secure messaging display. In this way, several embodiments of the peripheral devices effectively provide secure dynamic messaging and secure dynamic response. Conceptually, embodiments of the system can provide a secure communication channel within an unsafe communication medium such as the internet by using encrypted communications between highly secure endpoints. In several embodiments, the quality of the secure communication channel is similar to an out-of-band type communication channel, though it remains within band.

In several embodiments, the peripheral device is a card reader capable of reading data from one or more data cards. Conventional point of sale (POS) type card readers do not provide a secure communication channel for messages to a card reader display that can be used for authentication. Instead, conventional POS card readers include hardware, firmware and/or software that generally store a finite number of messages which can be displayed. However, these messages are not originated at a web server or a trusted authentication server, nor do they include specific transaction details or authentication details.

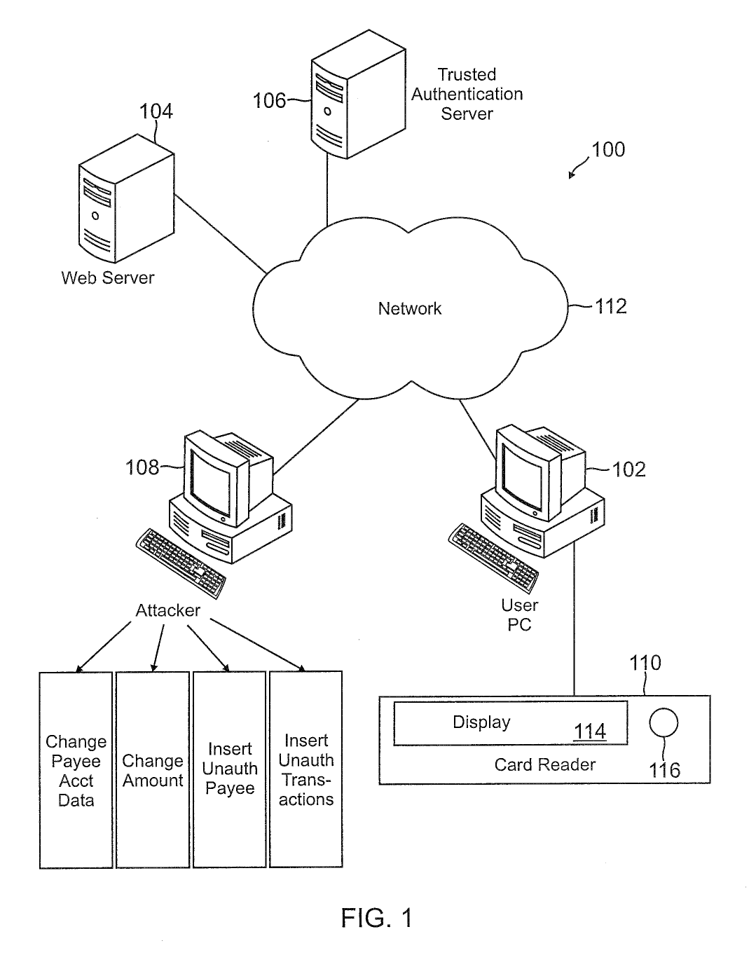

FIG. 1 is a schematic block diagram of a transaction system 100 including a user personal computer (PC) 102, a web server 104, a trusted authentication server 106, an attacker 108, and a card reader 110 having a message display in accordance with an embodiment of the invention. The user PC 102, web server 104, trusted authentication server 106 and attacker PC 108 are all coupled to a network 112 (e.g., the Internet). The card reader 110 is coupled to the user PC 102. In one embodiment, the card reader 110 is coupled to the user PC 102 using a universal serial bus (USB) connection. In other embodiments, the card reader 110 is coupled to the user PC 102 using other connections known in the art for coupling computing equipment.

In operation, a user may conduct a financial transaction using the user PC 102 and a web server 104 typically operated by a merchant or a bank. The attacker 108 may use any number of different methods to steal information from the user or to modify the transaction for the benefit of the attacker. For example, the attacker 108 may attempt to change the payee account data to re-route funds to another account, change the amount of the transaction, insert an unauthorized payee for the transaction, and/or insert unauthorized transactions. Typically, the attacker 108 would gain access to the transaction by having compromised the security of the user PC 102. In one such case, the attacker 108 might have stolen a password and/or an encryption key stored on the user PC 102 or entered by the user while a key logger was present. However, in order for the attacker to use any of the man-in-the-middle or other attacks, the attacker will generally have compromised the security of the user PC 102 or web server 104. In some embodiments, the attacker 108 may have control of the web server 104.

The card reader 110, however, does not use a hardware and software platform with the security flaws of the user PC 102. In several embodiments, the card reader 110 does not have a mechanism allowing for third party applications to be installed or downloaded. In some embodiments, the card reader 110 does not allow firmware updates without physical removal of one or more semiconductor chips. In one embodiment, the card reader 110 does not allow firmware updates at all. In some embodiments, the card reader 110 allows firmware updates but only after the components involved in the update, including the devices and new firmware, have been authenticated. In several embodiments, the card reader 110 includes a tamper resistant security housing that substantially prevents unauthorized access to components of the card reader. Embodiments of readers having tamper resistant housings are described in U.S. Pat. No. 7,703,676, the entire contents of which is incorporated by reference herein.

In order to avoid the potential attacks by the attacker 108, the card reader 102 and web server 104 can engage in a mutual authentication process. Once the card reader 102 has been authenticated, the web server 104 can send secure messages to the card reader 102 using encryption keys pre-loaded in the card reader 102 at the time of manufacturing. Those keys can be stored at the trusted authentication server 106 and provided to the web server 106 after the web server has been authenticated. The secure messages can be displayed on the display 114 of the card reader. The messages can be used to authenticate a data card, such as a magnetic stripe card or other suitable data card. The secure messages can also be used to authenticate transaction details such as account numbers, amounts, payees or other suitable transaction details.

A user input button 116 is also included on the card reader 110 for confirming information displayed on the card reader display 114. In a number of embodiments, the user can be prompted to confirm whether transaction details presented on the user PC screen match those details presented on the card reader display. In this way, a secure communication channel is provided to the user independent of the threats present on the user PC and on the network (e.g., internet). The user PC will not have knowledge of the card reader's encryption keys and will therefore not have access to the secure messages in an unencrypted form. In the embodiment of the card reader illustrated in FIG. 1, the user input 116 is a button. In other embodiments, other user input devices can be used. For example, in one embodiment, the user input can include a depressible scrolling ball for selecting from items in a list, a track ball, a touch screen and/or another tactile input(s). In some embodiments, no buttons are used and confirmation is indicated by a swipe of a data card. In some embodiments, an audio sensor such as a microphone that is capable of sensing a voice is used. In such case, the audio sensor can be capable of receiving voices and recognizing commands.

In some embodiments, a pin pad is displayed on the card reader display and the input enables selection of digits for a personal identification number (PIN) corresponding to the data card and/or card user. In some embodiments, the selection of PIN digits is made from a randomized list of numbers (e.g., linear scatter gram or a multi-dimensional scatter gram). In such case, the user can scroll from left to right (e.g., horizontally) and select the appropriate digits which are then displayed on a line above or below the randomized lists of numbers. In such case, no conventional pin pad button array is needed. In some embodiments, the web server can provide a set of multiple PINs, including one PIN that is the user's actual PIN while the other PINs are randomized fakes. In such case, the user can scroll to their PIN and make their selection. In some embodiments, the web server can securely provide a single use protection code to a requestor/user. In such case, the user can use the protection code for a subsequent transaction such as a purchase or automatic teller machine (ATM) transaction.

In the embodiment illustrated in FIG. 1, the card reader provides the display for displaying secure messages. In other embodiments, the card reader can be replaced by another peripheral device coupled to the user PC that has a display, one or more stored encryption keys and a secure device platform. In such case, the peripheral device also can be registered with the trusted authentication server and capable of executing a mutual authentication process.

In the embodiment illustrated in FIG. 1, the user PC is depicted as a desktop computer. In other embodiments, the user PC can be a laptop, a notebook computer, a tablet computer, or any other suitable computing device that can access a network such as the internet. In some embodiments, the user PC can be a cell phone such as a smart phone or another phone configured to access a network such as the internet.

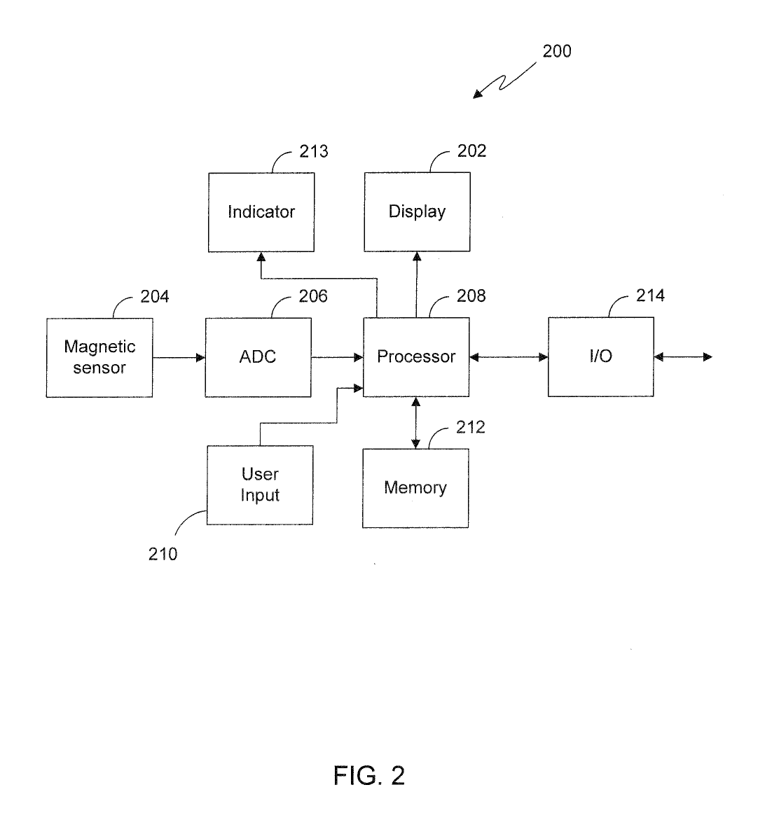

FIG. 2 is a schematic block diagram of a card reader 200 with a display 202 in accordance with an embodiment of the invention. The card reader 200 also includes a magnetic sensor 204 coupled to an analog to digital converter (ADC) 206 which is coupled to a processor 208. The processor 208 is also coupled to a user input 210, a memory 212, an indicator (e.g., light emitting diode or LED) and an input/output (I/O) port 214.

In operation, the card reader 200 can engage in a mutual authentication process with a web server or other entity to authenticate itself. The card reader 200 can also store one or more encryption keys or algorithms capable of generating encryption keys that are also known to a trusted authentication server. Once the mutual authentication process has verified authenticity of the card reader and/or web server, the web server can send messages and/or display commands to the card reader. The reader can display the messages and receive user feedback to the messages via the user input. The reader can encrypt the user response and send it to the web server.

The card reader can also perform a number of functions common to card readers. For example, in several embodiments, magnetic sensor 204 reads analog magnetic information stored on the magnetic stripe of a data card (such as the type commonly used for credit cards) and outputs an analog representation of this magnetic information to the ADC 206. The ADC 206 converts the analog information received from the magnetic sensor into a digital representation and transmits the digital representation of the magnetic data to processor 208. Processor 208 stores the digital information in memory 212. Processor 208 is configured to communicate via I/O port 214, which allows the card reader to communicate with the computer and/or other external devices over a data connection such as RS 232, RS 422, RS 485, EIA 530, Ethernet, USB, Bluetooth, WiFi, or another protocol for connecting communications equipment, as is well known in the art. In one embodiment, the I/O port is configured to communicate using a data connection to a computing device such as a smart phone via a headset input on the smart phone. In other embodiments, other suitable interfaces can be used to couple the card reader to a computer.

The indicator 213 can provide feedback to the user regarding actions related to the operation of the card reader. In one embodiment, for example, the indicator provides indication of a successful swipe of a data card. The indicator can be one or more light emitting diodes (e.g., LED matrix), a speaker, or another audible transducer. In one such case, the card reader can receive messages including audio content and output the audio content to the speaker. For example, in one embodiment, an audio message could notify the user of a particular code or password that is relevant to the user. The indicator can also be or include a tactile transducer.

In some embodiments of the invention, magnetic sensor 204 and ADC 206 may be a single unit which performs both the functions of sensing the magnetic strip and converting the analog data into a digital representation.

The processor 208 may be any sort of microprocessor suitable for use in an embedded system, such as a Z80 or an x86-based processor, as are well known in the art. In other embodiments, the ADC 206, the processor 208, the memory 212, and the I/O unit 214 or some subset of these may be appear in a single microcontroller chip such as a PIC, AVR, or ARM chip, as is well known in the art. In some embodiments, the processor can be a secure microcontroller. The secure microcontroller can include protection services and features such as tamper detection, memory clearing corresponding to detected tampering or other security related events, and other helpful tamper protection services.

In some embodiments, the card reader may additionally include a discrete unit for encryption, which, for the purposes of FIG. 2, can be considered as being part of the processor 208.

In several embodiments, the user input includes one or more buttons. In other embodiments, other user input devices can be used. For example, in one embodiment, the user input can include a depressible scrolling ball for selecting from items in a list, a track ball, a touch screen and/or another tactile input(s). In some embodiments, no buttons are used and confirmation is indicated by a swipe of a data card. In some embodiments, an audio sensor such as a microphone that is capable of sensing a voice is used. In such case, the audio sensor can be capable of receiving voices and recognizing commands.

In some embodiments, a virtual pin pad is displayed on the card reader display and the input enables selection of digits for a personal identification number (PIN) corresponding to the data card and/or card user. In some embodiments, the selection of PIN digits is made from a randomized list of numbers (e.g., linear scatter gram or multi-dimensional scatter gram). In such case, the user can scroll from left to right (e.g., horizontally) and select the appropriate digits which are then displayed on a line above or below the randomized lists of numbers.

In some embodiments, the user input can include systems for biometric identification using fingerprints, voice, retinal identification and/or other characteristics. In several embodiments, the biometric identification systems can acquire the characteristics using devices such as a microphone, a fingerprint scanner, a retinal scanner, or other suitable devices.

The display can be a liquid crystal display, a full graphics display or another display suitable for a peripheral computing device as is known in the art. In several embodiments, the display is configured to display text messages, graphical symbols, icons, graphic messages or other such messages. In such case, the user input can include appropriate selection devices to enable the user to select and/or confirm these types of messages.

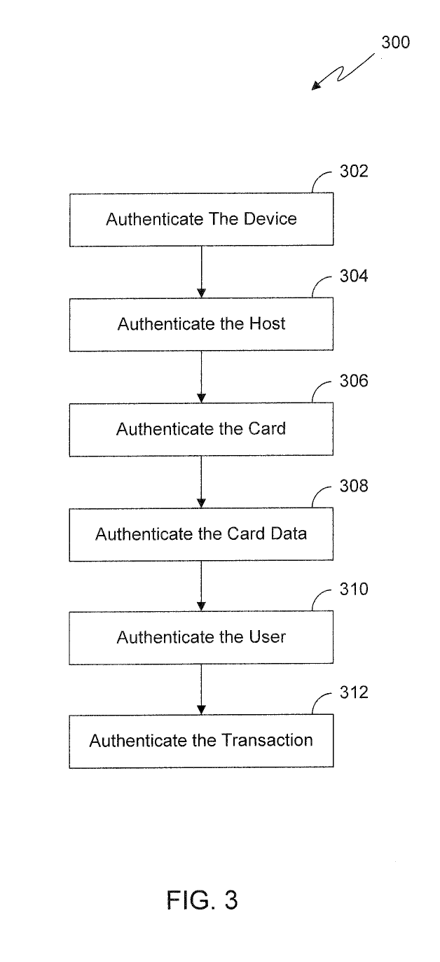

FIG. 3 is a flow chart of an overall process 300 for authenticating aspects of a card reader transaction in accordance with an embodiment of the invention. The process authenticates (302) the peripheral device such as a card reader. The process then authenticates (304) the host such as a web server, trusted authentication server, or other server entity. The process can authenticate (306) the data card or other suitable token used in the transaction. The process can authenticate (308) the card data stored on the data card.

In some embodiments, for example, the data card is a magnetic stripe card and the process extracts both the intrinsic magnetic characteristics or magnetic fingerprint and the card data from the magnetic stripe of the card. Systems and methods for reading and generating magnetic fingerprint information are described in U.S. Pat. Nos. 6,098,881, 6,308,886, 7,478,751, 7,210,627, and 7,377,433, and U.S. patent application Ser. Nos. 11/949,722 and 12/011,301, the entire content of each document is incorporated herein by reference. The magnetic fingerprint information can provide dynamic data per transaction which can be authenticated using correlation techniques. More specifically, the stochastic nature of the magnetic fingerprint can provide a level of security in the transaction making it more difficult for financial data associated with a card based transaction to be stolen or otherwise compromised.

After authenticating (308) the card data stored on the data card, the process can authenticate (310) the user. In several embodiments, the process authenticates the user by verifying one or more characteristics of the user such as a password, PIN, other identification number, fingerprint or optical scan, or other suitable authentication method. The process can then authenticate (312) the transaction. In several embodiments, the process authenticates the transaction using secure dynamic messaging and secure dynamic response. More specifically, the process can use secure messaging and the display and user input of the peripheral device (e.g., card reader) to authenticate transaction details and/or facilitate authentication of other aspects of the process (e.g., authenticating the card, etc.).

In one embodiment, the process can perform the sequence of actions in any order. In another embodiment, the process can skip one or more of the actions. In other embodiments, one of more of the actions are performed simultaneously. In some embodiments, additional actions can be performed.

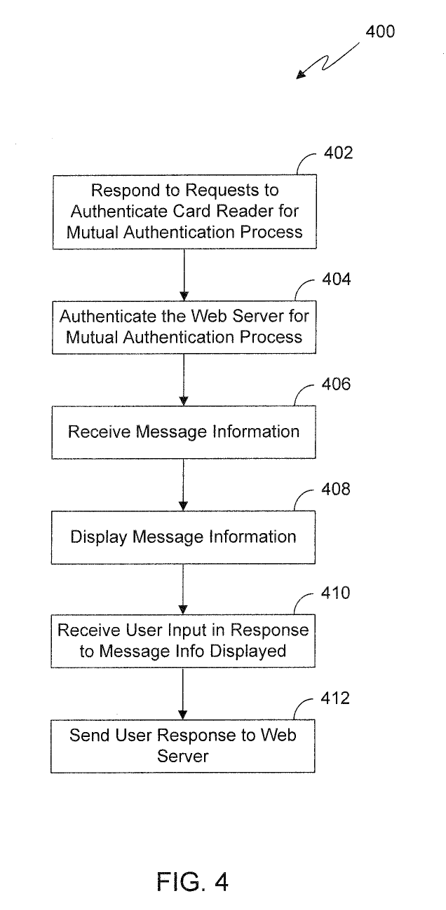

FIG. 4 is a flow chart of a process 400 for authenticating aspects of a card reader transaction at a card reader having a message display in accordance with an embodiment of the invention. The process responds (402) to requests to authenticate the card reader for a mutual authentication process. In several embodiments, the process can return a unique identifier of the card reader (e.g., a unique serial number assigned during the time when the reader was manufactured) to authenticate the reader. In other embodiments, other identifiers can be used. The process then authenticates (404) the web server for the mutual authentication process. In several embodiments, the web server returns a unique identifier such as a serial number or an encryption key known to the card reader. In some embodiments, the web server is replaced by one or more other server entities.

The process then can receive (406) message information from the web server indicative of one or more messages to be displayed and/or display commands for the card reader or other peripheral device. The process then can display (408) the message information on the card reader display. The message information can include text messages, graphical symbols, icons, graphic messages or other such messages. In some embodiments, the messages include information notifying the user of a particular access code, username, or password (e.g., passcodes, user codes, one time password, and the like) associated with that user.

The process can then receive (410) user input in response to the message information displayed. In one embodiment, for example, a number such as a transaction amount is displayed on the display and the user is asked to confirm that the amount is correct. In such case, the user input may include information indicative of a single confirmation button press. The process can then send (412) the user input response information to the web server.

In one embodiment, the process can perform the sequence of actions in any order. In another embodiment, the process can skip one or more of the actions. In other embodiments, one of more of the actions are performed simultaneously. In some embodiments, additional actions can be performed.

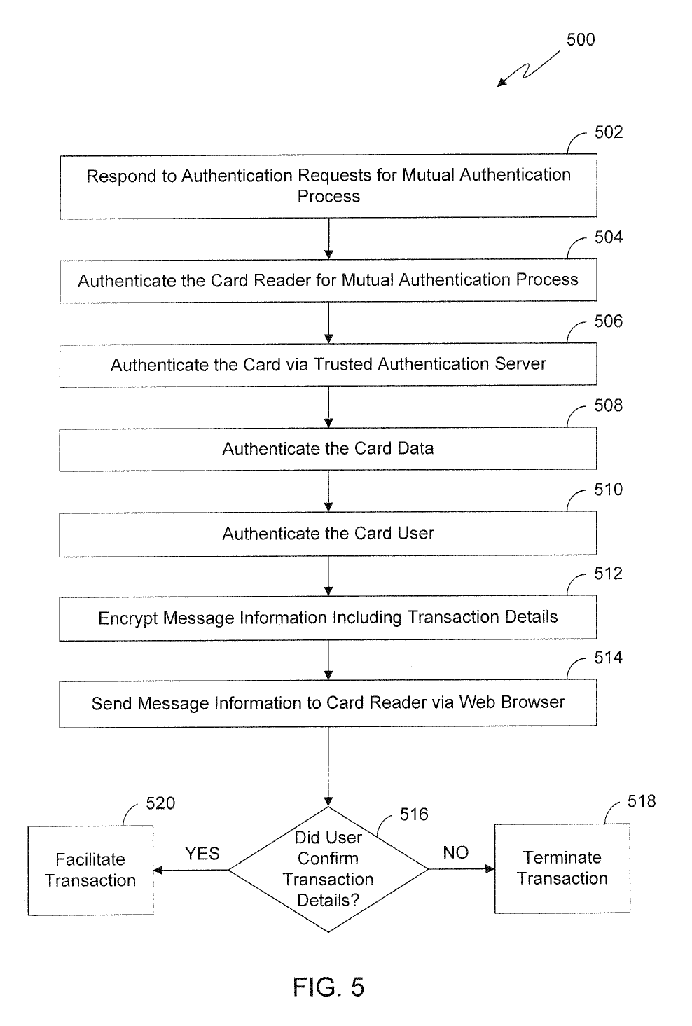

FIG. 5 is a flow chart of a process 500 for authenticating aspects of a card reader transaction at the web server in accordance with an embodiment of the invention. The process responds (502) to authentication requests in conjunction with a mutual authentication process with a card reader or other peripheral device. The process then authenticates (504) the card reader for the mutual authentication process. The process can then authenticate (506) the card via a trusted authentication server such as the one illustrated in FIG. 1. In several embodiments, the card reader can extract a magnetic fingerprint from the card and provide it to the web server. The web server can submit the magnetic fingerprint to the trusted authentication server which can return a score indicative of a degree of correlation between a stored version of the magnetic fingerprint recorded during card issuance and the value just read from the card. Based on the score, the web server can decide whether the card is valid. The process can then authenticate (510) the card user. In such case, the process can ask for unique identifiers of the user such as a username, password, and/or other suitable identifying information.

The process can then encrypt (512) message information including, for example, transaction details to be confirmed. In other embodiments, the message information can include other information. In one embodiment, the message information includes authentication details to be confirmed (e.g., a PIN to be confirmed). The process sends (514) the message information to the card reader, often via a web browser application running on the user PC. The process determines whether (516) the user confirmed the transaction details or other message information. If not, the process terminates (518) the transaction. In one embodiment, the process allows a preselected number of attempts for confirmation before terminating the transaction. If the user confirmed the transaction details, the process facilitates (520) the transaction.

In one embodiment, the process can perform the sequence of actions in any order. In another embodiment, the process can skip one or more of the actions. In other embodiments, one of more of the actions are performed simultaneously. In some embodiments, additional actions can be performed.

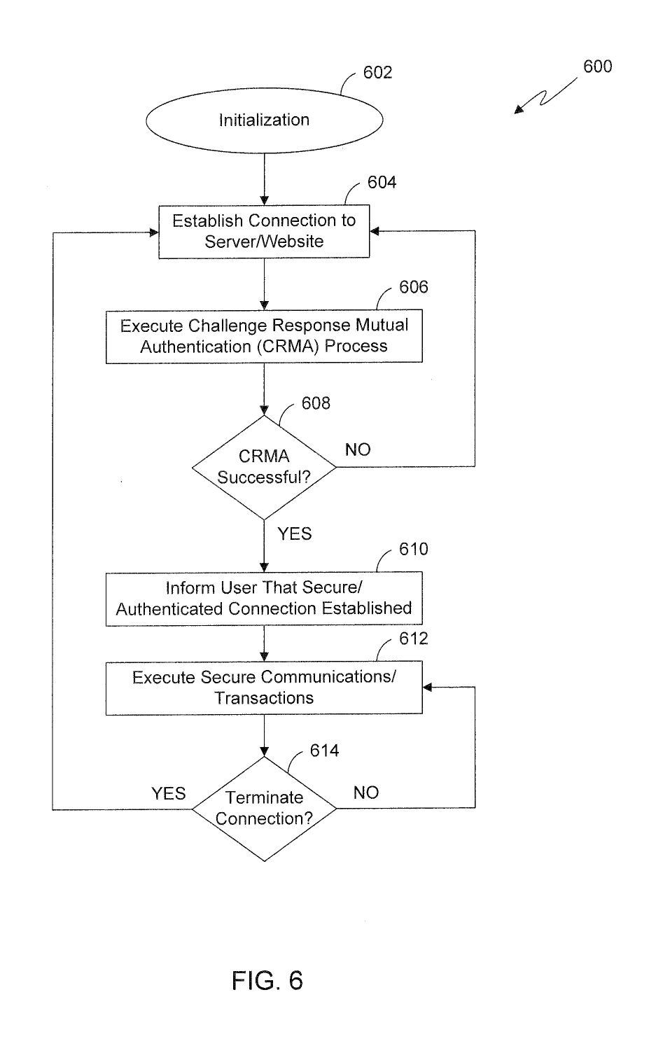

FIG. 6 is a flow chart of a process 600 for executing a mutual authentication process between a card reader and a web server in accordance with an embodiment of the invention. The process 600 begins with the initialization 602 of the card reader and any authentic websites for a mutual authentication process. In some embodiments, the initialization includes initializing the card reader and any authentic websites with one or more common security keys. In such embodiments, manufacturers of card readers and website providers have often established common security keys that are kept secret. The process then continues when the user of the card reader establishes (604) a connection to a web server or other remote server. The card reader and web server then execute (606) a mutual authentication process. In the illustrated embodiment, the card reader and website execute a challenge response mutual authentication (CRMA) process. In one embodiment, a Kerberos challenge response method is used. In some embodiments, challenge response mutual authentication may be implemented using symmetric encryption, one way functions, public key encryption and/or digital signatures. In another embodiment, any method of implementing a challenge response mutual authentication process known to one skilled in the art may be used to establish a secure and authenticated connection between the client and the server. In several embodiments, the card reader is the client and a website is the server for the CRMA process. In other embodiments, other methods of achieving mutual authentication can be used instead of CRMA.

If the mutual authentication process is not successful (608), then the process returns to allowing the user to establish (604) a connection to a website. If the mutual authentication process is successful (608), then the process informs (610) the user that a secure connection with an authentic website has been established. Once the connection is established, the user and/or card reader can execute (612) secure communications and/or transactions. The process can then determine whether the card reader and/or website wishes to terminate (614) the connection. If neither the card reader or website desires to terminate the connection, then the process can execute (612) additional secured communications and/or transactions. If either the website or card reader desires to terminate the connection, then the process can return to waiting for the user to establish (604) a new connection to a server or website.

In several embodiments, the user is informed (610) using an indicator associated with the magnetic stripe card reader. In some embodiments, the user is informed by a message on the user PC or on the card reader display. In some embodiments, the user is informed using both the indicator and one or more messages on the terminal. In one embodiment, the user is instructed to check the indicator or card reader display by a message on the terminal. Visual cues from the reader and website can thus instruct the user of a secure connection with an authentic website. Phishing and other consumer deception schemes can thus be reduced and/or prevented.

In one embodiment, secure transactions that can be established and protected also include transactions relating to non-financial websites that require confidential information such as a driver's license number, a date of birth, a social security number, medical information or other confidential information. In such secure transactions, the card reader can act in essence like a security feedback system that is transparent to the user.

In one embodiment, the process can perform the sequence of actions in any order. In another embodiment, the process can skip one or more of the actions. In other embodiments, one of more of the actions are performed simultaneously. In some embodiments, additional actions can be performed.

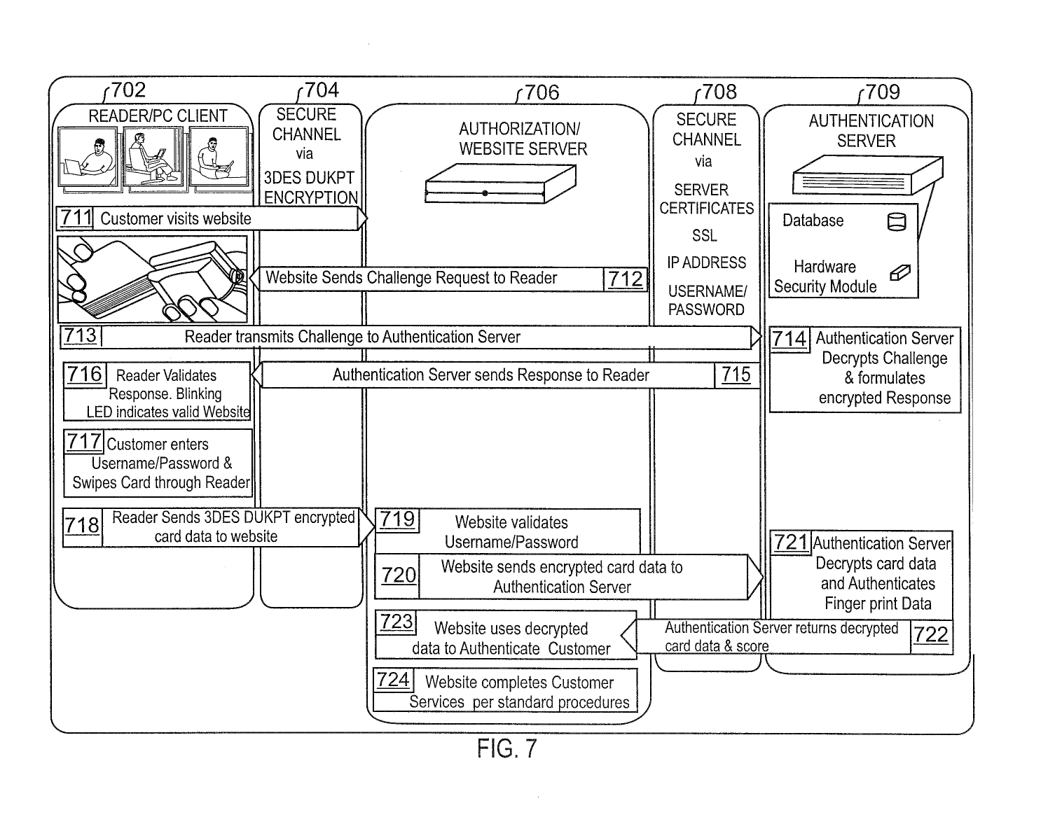

FIG. 7 is a functional block diagram/flow chart of a challenge-response mutual authentication process 700 that can be performed between a card reader, a web server, and an authentication server in accordance with an embodiment of the invention. The system includes a data card reader/PC client 702 coupled by a secure channel 704 to a authorization/website server 706. The website server 706 is coupled by a second secure channel 708 to an authentication server 709. The secure channel 704 can use triple DES derived unique key per transaction (DUKPT) encryption techniques to secure the channel. In other embodiments, other methods of encryption can be used to secure the channel 704. The second secure channel 708 can use any combination of server certificates, secure sockets layer (SSL), and/or internet protocol (IP) addresses to secure the channel.

The process can begin when a customer using the reader/PC client visits (711) the website of the website server. The website can respond by sending (712) a challenge request to the reader. In a number of embodiments, the reader can respond to the challenge request issued by the website by sending the challenge request back to the website in an encrypted form using a common encryption key. The reader then transmits (713) a challenge to the authentication server. The authentication server decrypts (714) the reader's challenge and formulates an encrypted response. The authentication server then sends (715) the formulated response to the reader. The reader validates (716) the response. A blinking LED or message on the display of the reader can indicate a valid website.

The customer enters (717) the customer's username/password and swipes the data card through the reader. The reader sends (718) triple DES (3DES) DUKPT encrypted card data to the website. The website validates (719) the customer's username/password. The website then sends (720) the encrypted card data to the authentication server. The authentication server decrypts (721) the card data including magnetic fingerprint data and authenticates the magnetic fingerprint data. The authentication server then returns (722), to the website, the decrypted card data and a score indicative of the degree of correlation between the magnetic fingerprint data read from the data card during the transaction and a stored value. The website uses (723) the decrypted data to authenticate the customer and/or customer transaction. The website can then complete (724) the services requested by the customer using standard procedures, including, for example, sending messages to be displayed on the secure display of the card reader.

In one embodiment, the process can perform the sequence of actions in any order. In another embodiment, the process can skip one or more of the actions. In other embodiments, one of more of the actions are performed simultaneously. In some embodiments, additional actions can be performed.

In several embodiments, the username can be an identifier intended for one time use. In such case, the identifier can include the magnetic fingerprint of the data card engaged in the current transaction. In one embodiment, the password can be a value intended for one time use. In such case, the password value can include the magnetic fingerprint of the data card engaged in the current transaction. In another embodiment, the username, password and magnetic fingerprint of the data card engaged in the current transaction can be combined to form a digital signature intended for one time use.

In one embodiment, the reader is configured to output encrypted data including card track data, magnetic fingerprint data, sequence counter data and cyclic redundancy check (CRC) data. In another embodiment, the reader is configured to output unencrypted or clear text data including key serial number data, DUKPT counter data, masked data, CRC data, and reader serial number data.

In another embodiment, the trusted authentication server is integrated with the user PC or transaction terminal. In such case, authentication of a card can take place at the transaction terminal. In this example of localized authentication, the card authentication information including the intrinsic magnetic characteristics of the data card can be stored in an encoded form (stored reference fingerprint) on the data card. The transaction terminal can receive the intrinsic magnetic characteristic of the card (transaction fingerprint) and stored information including the stored reference fingerprint from the card reader. Using this information, the terminal can perform the scoring process at the terminal. A score indicative of the degree of correlation of the fingerprint read from the card and the stored fingerprint can be generated. Based on the score, the terminal can determine whether or not the card is authentic.

In another embodiment, the data card reader includes a remote key loading feature which enables a remote server or other computing device to load an encryption key onto the reader. In one embodiment, the authentication system, including the authentication server and/or the trusted scoring system, can enable remote key loading. In one such case, a data card reader can include a secure mode for securely loading encryption keys. Special information provided to the reader can cause the reader to enter the secure mode. In another embodiment, the data card reader can include multiple levels of security. In such case, each level can correspond to a different degree of security and a level of encryption used. In one embodiment, the highest level of security can require that all data received and sent by the reader is encrypted.

In one embodiment, a remote computing device can use an existing encryption key, one that is generally used for encrypting data read by the data card reader, in conjunction with a security sequence to enter the secure mode and remotely load one or more encryption keys. In another embodiment, the remote computing device can use a special manufacturing encryption key in conjunction with a security sequence to enter the secure mode and remotely load one or more encryption keys. In such case, the remotely loaded keys can replace the existing encryption keys. In several embodiments, the encryption keys used are DUKPT encryption keys. In some embodiments, the manufacturing key can be known only by the card reader itself and the manufacturer of the reader. Additional embodiments of systems capable of remote loading encryption keys are described in U.S. Provisional Patent Application No. 61/382,436, the entire content of which is incorporated herein by reference.

In a number of embodiments, the data card reader is equipped with a means of providing audio, visual or tactile feedback to the user. In a number of embodiments, the feedback can relate to whether the card reader has been authenticated and/or whether a swiped data card has been authenticated. In a number of embodiments, the visual feedback can be conveyed using one or more light emitting diodes (LEDs). In one embodiment, the audio feedback is conveyed using a speaker.

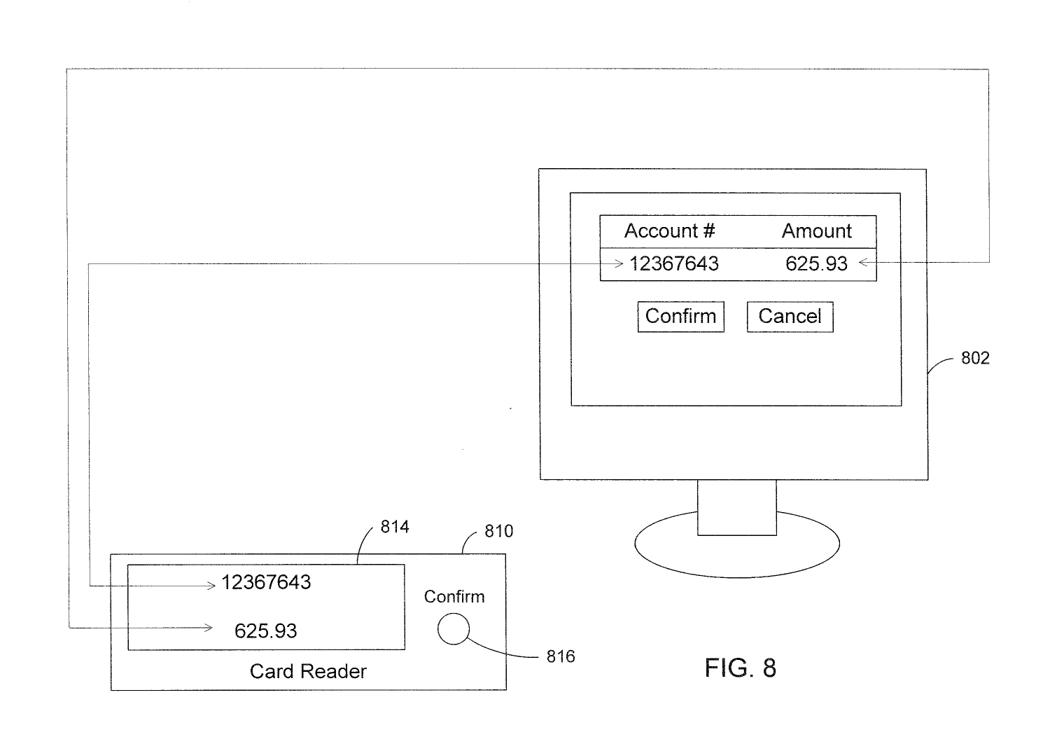

FIG. 8 is a schematic block diagram/screen shot of displays of a user PC 802 and a card reader 810 illustrating a process for confirming details of a transaction displayed on the secure message display 814 of the card reader in accordance with an embodiment of the invention. In operation, details of a financial transaction are displayed on the card reader message display 814. The user of the user PC 802 and card reader 810 can confirm that the details displayed are correct. In the embodiment illustrated in FIG. 8, the transaction details (e.g., account number and amount) are also displayed on the user PC display 802. The user can press a confirmation button 816 to confirm whether the transaction details displayed on the reader display 814 match those displayed on the user PC 802. In addition, the user can confirm these details with confirmation and/or cancel buttons displace on the user PC 802. In several embodiments, the card reader display rotates different fields of the financial transaction for consideration/confirmation. In the embodiment illustrated in FIG. 8, for example, the card reader display can first display the account number for confirmation and subsequently display the amount for confirmation. In other embodiments, other display methods and inputs can be used to facilitate appropriate confirmation of transaction details or for authentication purposes as discussed above.

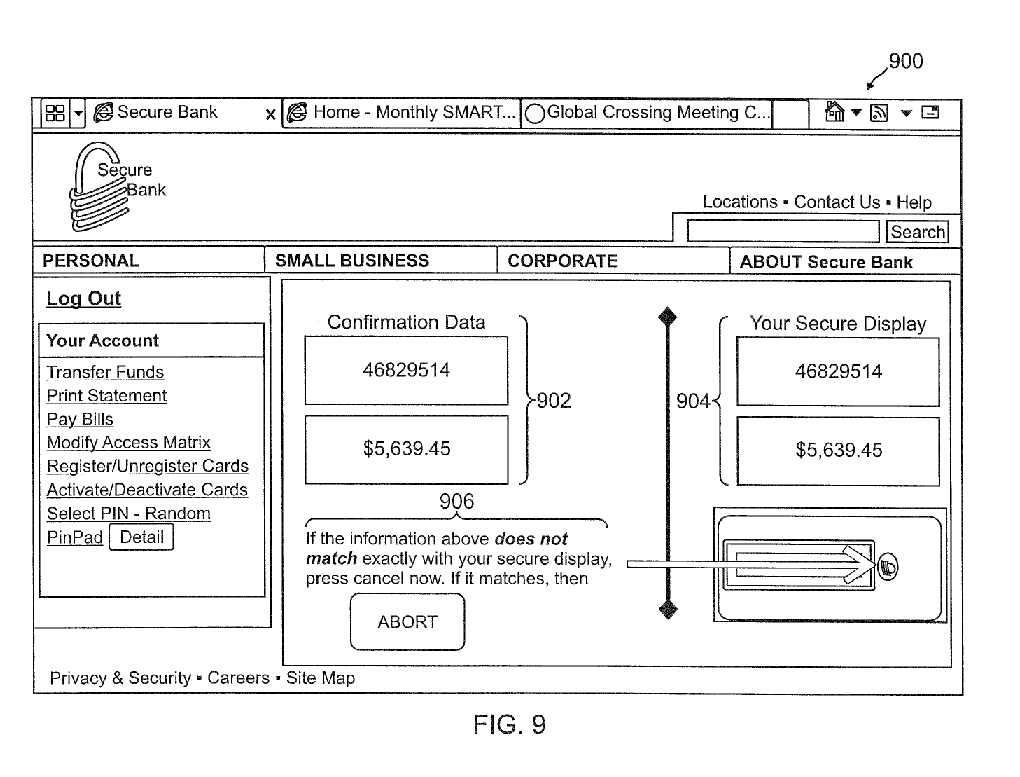

FIG. 9 is a screen shot of a user PC display 900 illustrating a process for confirming details of a transaction displayed on the secure message display of the card reader in accordance with an embodiment of the invention. The display 900 includes confirmation data 902 for the transaction details and a depiction 904 of those transaction details that should also appear on the secure message display (not shown) of the card reader. The display 900 further includes instructions 906 for confirming the transaction details if there is a proper match between the PC display details and the secure display details. In several embodiments, the user PC display 900 is a window from a web browser.

While the above description contains many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents.

In several embodiments, the card reader and/or web server are authenticated using various mutual authentication techniques. In other embodiments, the card reader and/or web server are authenticated using other suitable authentication techniques.

In several embodiments, the peripheral device with a secure messaging display is used in conjunction with a user PC. In some embodiments, the peripheral device with a secure messaging display can be used without the user PC. In several embodiments, the peripheral device with a secure messaging display is used with a handheld computer such as a smart phone or another similar computing device.

What is claimed is:

1. A system for establishing a secure communication channel between a computer peripheral device and a host, the system comprising:
a host;
a computer coupled to the host via an unsecured communication channel; and
a peripheral device coupled to the computer and comprising:
a display configured to display one or more messages received from the host;
at least one input configured to receive information from a user; and
processing circuitry configured to:
establish a secure communication channel with the host using a mutual authentication process;
receive the messages from the host via the computer using the secure communication channel; and
send the user information to the host via the computer using the secure communication channel.

2. The system of claim 1, wherein the processing circuitry is further configured to:
receive encrypted messages from the host;
decrypt the encrypted messages using the one or more encryption keys;
encrypt the information received by the user using the one or more encryption keys; and
send the encrypted user information to the host via the computer.

3. The system of claim 1, wherein the peripheral device is a card reader configured to read information stored on a data card.

4. The system of claim 1, wherein the one or more messages comprise a message selected from the group consisting of a text message, a graphical symbol, an icon, and a graphic message.

5. The system of claim 1, wherein the at least one input comprises a device selected from the group consisting of a button, a track ball, a touch screen, an audio sensor, and a biometric identification device.

6. The system of claim 1, wherein the processing circuitry is configured to provide information to the host to authenticate the peripheral device.

7. The system of claim 1:
wherein the peripheral device is a card reader configured to read information stored on a data card;
wherein the card reader is configured to extract a magnetic fingerprint from the data card and send the magnetic fingerprint to the host to authenticate the data card.

8. The system of claim 1, wherein the one or more messages comprise a message prompting a user to enter a personal identification number.

9. The system of claim 1, wherein the secure communication channel is not accessible by the computer.

10. The system of claim 1, wherein an encryption key required for decrypting information passing along the secure communication channel is not stored on the computer.

11. The system of claim 1, wherein the host comprises a website server, and wherein the computer accesses the website server using a browser software.

12. The system of claim 11:
wherein the peripheral display displays a first message from the host, and
wherein the browser software displays the first message.

13. The system of claim 12, wherein the browser software displays a second message prompting the user to confirm that the first message displayed on the display and the first message displayed in the browser software are identical.

14. The system of claim 1, wherein the processing circuitry is configured to perform remote encryption key loading.

15. The system of claim 1:
wherein the peripheral device is a card reader configured to read information stored on a data card,
wherein the card reader is configured to extract a magnetic fingerprint from the data card and send the magnetic fingerprint to the host to authenticate the data card,
wherein the data card is configured to store recorded data comprising a magnetic fingerprint previously extracted from a magnetic medium of the data card, and
wherein the processing circuitry is configured to perform a local authentication of the data card based on a magnetic fingerprint extracted from the magnetic medium of the data card during a requested transaction and the magnetic fingerprint stored in the recorded data of the data card.

16. A method for establishing a secure communication channel between a computer peripheral device and a host, the method comprising:
responding to requests to authenticate the peripheral device;
authenticating the host;
receiving one or more messages from the host;
displaying the one or more messages on a display of the peripheral device;
receiving user input in response to the one or more messages;
sending the user response to the host.

17. The method of claim 16, wherein the peripheral device is a card reader configured to read information stored on a data card.

18. The method of claim 16, further comprising:
receiving a request from a user to facilitate a financial transaction with payment by a data card;
authenticating the data card;
authenticating the user; and
authenticating the transaction.

19. The method of claim 18, wherein the authenticating the data card comprises:
authenticating a magnetic fingerprint of the data card; and
authenticating recorded data stored on the data card.

20. The method of claim 16, wherein the receiving the one or more messages from the host comprises:
receiving encrypted information from the host; and
decrypting the received information into the one or more messages.

21. The method of claim 16, wherein the sending the user response to the host comprises:
encrypting the user response; and
sending the encrypted user response to the host.

22. The method of claim 16, further comprising:
responding, at the host, to requests to authenticate the host;
authenticating the peripheral device;
authenticating a data card presented at the peripheral device by a user for a financial transaction; and
authenticating the card user.

23. The method of claim 22, further comprising:
encrypting a first message comprising details associated with the financial transaction;
sending the first message to the peripheral device;
displaying, at the peripheral device, the first message;
prompting the user to confirm one or more of the financial transaction details of the first message;
receiving user input; terminating the financial transaction if the user did not confirm the financial transaction details; and
facilitating the financial transaction if the user confirmed the financial transaction details.

24. The method of claim 16, wherein the one or more messages comprise a message selected from the group consisting of a text message, a graphical symbol, an icon, and a graphic message.

25. The method of claim 16, wherein the user input is received from a device selected from the group consisting of a button, a track ball, a touch screen, an audio sensor, and a biometric identification device.

26. The method of claim 16, wherein the peripheral device is a card reader configured to read information stored on a data card, the method further comprising:
extracting, at the card reader, a magnetic fingerprint from the data card and sending the magnetic fingerprint to the host to authenticate the data card.

27. The method of claim 16, further comprising performing, at the peripheral device, remote encryption key loading.

28. The method of claim 16, wherein the peripheral device is a card reader configured to read information stored on a data card,
storing, at the data card, recorded data comprising a magnetic fingerprint previously extracted from a magnetic medium of the data card; and
performing, at the card reader, a local authentication based on a magnetic fingerprint extracted from the magnetic medium of the data card during a requested transaction and the magnetic fingerprint stored in the recorded data of the data card.
